(19) United States
(12) Patent Application Publication
(10) Pub. No.: US 2009/0026141 A1
(43) Pub. Date: Jan. 29, 2009

(54) EFFLUENT TREATMENT PROCESS

(75) Inventor: Robin Edmund Guthrie Robinson, Houghton (ZA)

Correspondence Address: WALKER & JOCKE, L.P.A., 231 SOUTH BROADWAY STREET, MEDINA, OH, 44256, US

(73) Assignee: Darryl Howard

(21) Appl. No.: 12/279,429

(22) PCT Filed: Feb. 14, 2007
(86) PCT No.: PCT/IB2007/000335

§ 371 Date: Aug. 14, 2008

(30) Foreign Application Priority Data
Feb. 14, 2006 (ZA) 2006/01313

(51) Int. Cl. C02F 1/42; C05D 9/02

(52) U.S. Cl. 210/665; 210/670; 210/673; 210/677; 71/63

(57) ABSTRACT

A process for the treatment of effluent, particularly acid mine drainage, is provided which includes the steps of a. neutralising acid; b. removing cations by ion exchange using a cation resin; c. regenerating the cation resin; d. treating the eluates of the cation ion exchange step; e. adsorbing anions from the effluent of the cation removal step using an anion exchange resin; and f. regenerating the anion exchange resin.

### FIELD OF THE INVENTION

This invention relates to a process for the treatment of aqueous effluents containing environmentally toxic materials such as acids and metals, more particularly, but not exclusively, to acid mine drainage.

### BACKGROUND TO THE INVENTION

Acid mine drainage (AMD) is a common effluent from mines in which sulphidic minerals are present and which can form sulphuric acid and metal sulphates. If untreated AMD can seriously pollute water resources and land areas. There are a wide variety of such effluents from the coal, gold and base metal mines and the composition of these effluents varies widely regarding the toxic constituents present.

Present methods of treating AMD generally require extensive capital outlay, are expensive to operate and are specific in their application to a particular effluent. For this reason, AMD is often only partially treated or left untreated in underground or open reservoirs. The water component from both partially treated effluent and untreated effluent is kept in open reservoirs and is allowed to evaporate. This is quite unsatisfactory in that the toxic constituents remain and often leak from the reservoirs, and in that much water is wasted in the process.

Currently AMD is pre-treated using a high density separation (HDS) process producing a sludge product (stored in open reservoirs) and neutralised mine drainage (NMD). Currently this NMD is either discharged into rivers or used as agricultural water, neither of which is considered to be environmentally sustainable. Further processing the NMD can be achieved through reverse osmosis (RO) or biological processes (both produce additional toxic waste) for use as potable or agricultural water. No other saleable products are produced in significant quantities.

Current AMD treatment solutions are not economically viable. The operational cost of current HDS technologies exceeds the revenue and this cost is exacerbated when used in combination with RO and/or biological solutions to further treat the NMD. All of the aforementioned treatment solutions are considered to be environmentally unsustainable as both produce a toxic waste to be stored in slimes dams and/or discharge a potentially hazardous liquid effluent into the environment.

### OBJECT OF THE INVENTION

It is an object of this invention to provide an effluent treatment process which will at least partially alleviate some of the abovementioned problems.

### SUMMARY OF THE INVENTION

In accordance with this invention there is provided a process for the treatment of effluent which includes the steps of
a. neutralising acid;
b. removing cations by ion exchange using a cation resin;
c. regenerating the cation resin;
d. treating the eluates of the cation ion exchange step;
e. adsorbing anions from the effluent of the cation removal step using an anion exchange resin; and
f. regenerating the anion exchange resin.

Further features of the invention provide for the acid to be neutralised by adding a weak to medium base anion exchange resin in the free base and OH form to absorb excess acid; and for the anion exchange resin to be the same as used for the adsorption of anions.

Still further features of the invention provide for nitric acid to be used as the eluant (regenerant) so that the eluate contains the cations as their nitrate salts; and for a high concentration of nitric acid to be used.

Yet further features of the invention provide for the eluates of the cation ion exchange step to be treated by passing ammonia gas therethrough to neutralise any excess acid, converting ferrous ions to ferric ions using air or oxygen to obtain a precipitate as the hydrate at pH 3.5; for the precipitate to be removed by filtration and dried; and for the filtrate to be adjusted to a neutral pH, evaporated and crystallized to form a mixed fertiliser by-product.

Further features of the invention provide for the anion exchange resin to be a resin with weak base characteristics; and for the effluent from the anion absorption step to be water of domestic quality.

Still further features of the invention provide for the anion exchange resin to be regenerated using ammonia gas introduced into a circulating solution of ammonium sulphate passing through the resin so as to maintain a pH of just above 7; and for ammonium sulphate to be removed from the circulating eluate by bleeding off a stream and concentrating it to a saturated solution or crystallising out a solid fertiliser.

Yet further features of the invention provide for a scavenger column to be used to remove any ammonium anions in the domestic product water; for a cation exchange resin in the hydrogen (acid) form which absorbs the ammonia as the ammonium cation to be used in the scavenger column; and for the loaded resin to be regenerated with sulphuric acid and the eluate to be neutralized and added to the eluate from the anion regeneration step.

### BRIEF DESCRIPTION OF THE DRAWINGS

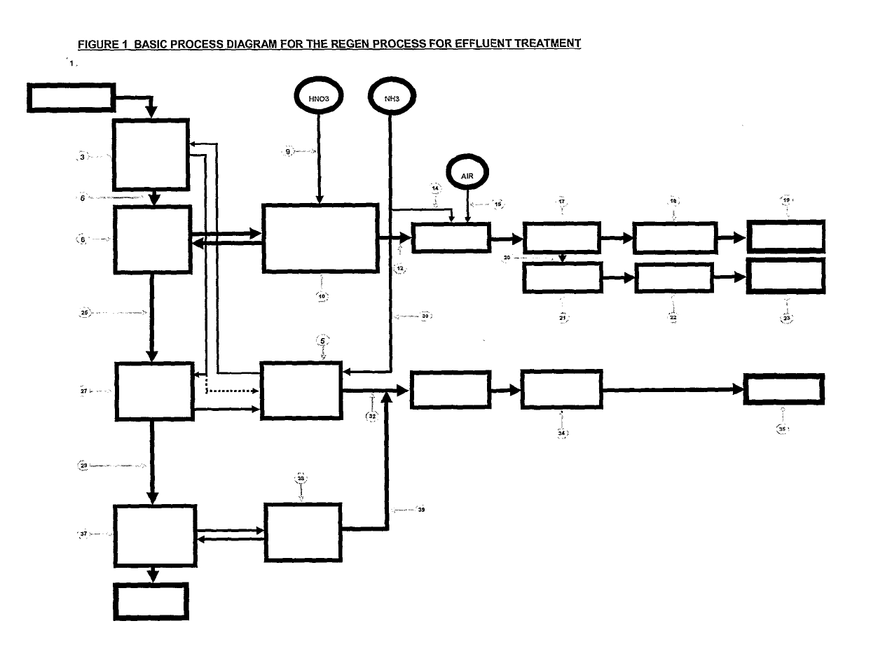

One embodiment of the invention will be described, by way of example only, with reference to FIG. 1 which is a flow chart for a process for treating an effluent.

### DETAILED DESCRIPTION OF THE DRAWINGS

The process of the invention is built around a limited number of core process operations, namely the use of ion exchange (IX) resins to remove in sequence the cations and the anions in the effluent, and the regeneration of these ion exchange resins with the so-called fertiliser acids and bases so that the impurities can be recovered as saleable materials many of which are agricultural fertilisers.

Referring to FIG. 1, a feed (1) containing sulphuric acid, ferrous sulphate, soluble calcium and magnesium sulphates arising from, in this embodiment, contact with limestone and dolomite in a mine (not shown), and wherein the sodium and potassium contents are below the specifications for domestic product water, is fed to a first IX column (3) where acid in the feed (1) is neutralised. In this embodiment, a weak to medium base anion exchange resin in the free base and OH form is used to absorb excess acid. This has many advantages over the commonly used lime addition in that no additional ions are introduced into the circuits, such as calcium or magnesium, as these invariably represent impurities which have to be removed. The same anion resin as used in the anion absorption steps can be supplied from the inventory of regenerated resin, and after use, can be returned for regeneration (5).

This is a novel feature of this invention and has several other advantages. The resin provides accurate pH control and can provide selective precipitation methods as to be described later. The reactions are rapid and standard stirred tank equipment can be used with simple and low cost methods commonly known in IX practice for screening off the resin from the solutions.

In special circumstances a different anion resin can be used for the neutralizing step and this resin can be regenerated separately. An abrasion resistant resin might be used if the neutralization is carried out underground before the mixture is pumped to the surface.

After acid neutralisation, the solution (6) is fed to a further IX column (8) for cation removal. A standard commercial resin with a high chemical resistance can be chosen when nitric acid (9) is used for elution (10), as is the case in this embodiment. Depending on the quantity and clarity of the solution and the concentration of impurities in the solution, a number of different standard designs of equipment can be selected such as column, multistage counter current or up-flow techniques. Ultra large scale equipment to treat thousands of megalitres per day is commercially available. The typical cations present can be removed to levels well below the specifications for domestic water whilst resin losses and inventory costs are well within the affordable cost levels.

As indicated, nitric acid (9) is selected as the eluant (regenerant) for resin regeneration (10) in this embodiment. This has the result that the eluate (12) will contain the cations as their nitrate salts. It is important that a high concentration of nitric acid (9) is used for the elution (10) and there be as little dilution of the eluate with water as possible. For the sale of a fertiliser by-products in solid form any water introduced in the elution has to be evaporated which implies a significant cost factor.

In this embodiment, the constituents in the concentrated eluate (12) include ferrous, ferric, calcium and magnesium cations associated with nitrate anions, and some excess nitric acid. The eluate (12) is next treated by neutralising the acid with ammonia gas (14) and further bubbling air (15) or oxygen through the solution to convert the ferrous ion to ferric ions. This is precipitated as the hydrate at pH 3.5 where after it is removed by filtration (17) and dried (18) to form a high purity red oxide pigment (19) as a by-product.

The filtrate (20) from filtration (17) contains ammonium, calcium and magnesium nitrates and is adjusted to a neutral pH value (21) where after it is evaporated and crystallized (22) to form a mixed fertilizer by-product (23).

The effluent (25) from the cation absorption column (8) contains sulphuric acid and, in this embodiment, this is absorbed on a weak base resin in an anion exchange column (27). Such commercially available resins contain some medium base groups but these do not affect the operation of this step. The characteristic of the weak base resin is that the primary amine groups can absorb anions below a pH value of 7, but at this pH value and above the primary amine converts to a free base with no ion exchange properties. Thus this resin will absorb the sulphate from the acidic solution. The resin can be easily regenerated by any alkaline reagent which provides an eluant at or above a pH of 7. The absorption reaction can be carried out in any of the conventional forms of equipment suitable for the scale of operations. The effluent (29) from the anion absorption step is substantially free of ionic constituents and suitable for domestic quality use except that it may contain small amounts of ammonia as explained below.

The weak base resin is regenerated (5), in this embodiment, using ammonia gas (30) introduced into a circulating solution of ammonium sulphate passing through the resin so as to maintain a pH above 7. The reason for this is to minimise the amount of undissociated ammonium hydroxide or ammonia gas being adsorbed in the gel structure of the resin beads. This will appear in the absorption effluent (29) and contaminate the product water. The use of ammonia gas is desirable so that the minimum amount of water can be maintained in the eluate thus reducing the evaporation cost of the fertiliser product, ammonium sulphate, obtained from the eluate (32). The by-product from the regeneration (5) is ammonium sulphate which is taken off the circulating eluate (32) as a bleed and concentrated to a saturated solution or, in this case, crystallized (34) as solid fertilizer (35) both of which are saleable commodities.

The presence of small amounts of ammonium anions in the domestic product water (29) can be removed using a scavenger column (37) of a cation exchange resin in the hydrogen (acid) form which absorbs the ammonia as the ammonium cation. The loaded resin can be regenerated (38) with sulphuric acid and the eluate (39) containing a concentrated solution of ammonium sulphate and a small amount of sulphuric acid is neutralised and added to the eluate (32) from the anion regeneration step. The size of this scavenger step is small compared to the other process steps. If the product water is used for agricultural purposes, this scavenger step can be omitted.

The quality of the water produced in terms of total dissolved solids is better than domestic specifications. However the quality of the by-products can be influenced by the presence of other impurities particularly sodium and chloride ions/in certain types of AMD. It is a feature of this invention that alternative options can be readily built into the base process to cater for variations in feed and output parameters as follows.

### Presence of Insoluble Material and High Aluminium Content in Feed Water

In many cases the feed water will have been in contact with clay minerals which are difficult to flocculate and give rise to high aluminium content. The conventional approach is to add lime to precipitate and flocculate such materials and this is known as the High Density Sludge (HDS) process. The lime addition gives a precipitate which adds to the material to be removed and disposed of. This invention can be used not only to neutralise the free acid but prior to the cation absorption step to precipitate the iron and aluminium in the feed water using a base form of an anion exchange resin to increase the pH to 6.5-7 with the bubbling of air or oxygen into the feed solution. The iron and aluminium form precipitates which flocculate readily and collect the fine solid material in the feed. These precipitates can be removed by sedimentation and filtration and can be disposed of as colouring fillers in roof tiles or in landfill. The elimination of excessive amounts of insoluble material enables the IX processes to be operated without difficult clarification steps.

### Presence of Sodium and Chloride

Although the process described above can remove sodium and chloride from the final product water, these ions will appear in the calcium nitrate and ammonium sulphate fertilisers with adverse effects on the quality and value of these materials. However these monovalent ions are not absorbed as strongly as the multivalent metal and sulphate ions and they can be displaced from the resins at the bottom of a column operation. It thus becomes possible to reabsorb these ions on a separate side column and recover them as saleable by-products. In the case of sodium, the side column can be regenerated with nitric or phosphoric acid producing sodium nitrate or sodium phosphate both of which are saleable materials. In the case of the chloride, the side column can be regenerated with magnesium oxide to give an eluate from which magnesium chloride can be produced and converted by standard chemical processing into hydrochloric acid which is readily saleable and magnesium oxide which is reused in the regeneration.

### Presence of Other Toxic Metals

Toxic metals such as uranium (and its daughter product, radium) nickel, cobalt and copper are metals often present in AMD. These will be removed in the cation column and appear in the eluate as nitrates. There are a number of established processes to extend the precipitation steps to recover these metals as saleable products. The uranium can be precipitated as ammonium diuranate, a readily saleable material, and the other metals can be recovered using techniques such as solvent extraction and electro-deposition. It is probably best to precipitate all of them together as hydrates by the process of this invention using a basic form of an anion exchange resin and to sell them as such to specialists.

### Use of Phosphoric Acid and Potassium Carbonate as Regenerants

A complete range of fertilisers can be produced by using phosphoric acid as the regenerant for the cation resin and potassium carbonate as the regenerant for the anion resin. A range of NPK fertilisers will have the advantage of allowing more scope in the marketing of by-products, and of obvious advantage if the product water were to be used in agriculture. Some minor changes to the basic flow sheet would be desirable. In the case of the phosphoric acid, it would be desirable to remove the ferric ions prior to the cation exchange (8). This is because ferric phosphate is insoluble and not readily saleable. The eluate would thus produce calcium, ammonium and magnesium phosphates as fertilisers. In the case of the anion regeneration, potassium sulphate would be the saleable product. An advantage of using potassium carbonate would be the elimination of the scavenger column (37).

### Use of the Product Water for Agricultural Irrigation

The product water from the basic process is of a much higher quality than that needed for agricultural purposes. However there are many cost advantages in adding the appropriate fertilisers in a solution form from the eluates resulting in considerable cost savings in evaporation, crystallization and packaging. The efficiency of fertilizer is much higher when fed as a solution. Although there is a wide variety of compositions of AMD the quantities of fertilizer produced by this process is in excess of normal irrigation requirements. However the purity of the product water is such that it could be used as a diluent for other effluents, such as domestic effluent, to bring the mixture to within the agricultural specifications, thus increasing the amount of water available, markedly at very low cost, and increasing agricultural productivity and consumption of fertilisers. This is an important consideration in sustainability of communities associated with mines having to treat AMD effluent.

Treatment of Effluents with Excessive Amounts of Sulphuric Acid

In some instances the effluent contains abnormally high concentrations of sulphuric acid and in using the basic process an excessive amount of ammonium sulphate will be produce which might be difficult to sell. In such cases the anion resin used to neutralize the free acid can be regenerated not with ammonia but with lime in a separate unit. This is a known process and gypsum is produced as a by-product. However in this modification the by-product is of high purity compared with the normal product produced in such commercial water treatment processes and is a readily saleable product for fillers in paper, paints and plastics and can be readily converted into many high quality building products. This modification would not cause any contamination of the domestic product water, nor would it create any environmental problem. If justified in terms of the relative marketability of ammonium sulphate and gypsum the main stream anion exchange resin could also be regenerated using lime.

From the above, it will be apparent that the process of this invention is highly effective and can be used with minor modifications to treat an almost complete range of AMD effluent and compositional variations.

The invention provides an economic, zero-effluent (no contribution to slimes dams), chemical process to produce a range of saleable products, including water (potable or fertiliser-enriched), solid fertilisers and saleable by-products, from AMD directly. The invention represents an environmentally and economically sustainable solution to the treatment of AMD. Economic sustainability is linked to the fact that the revenue from this process sufficiently exceeds the cost of operation to make the process economically viable.

1. A process for the treatment of effluent which includes the steps of
a. neutralising acid by adding a weak to medium base anion exchange resin in the free base and OH form to absorb excess acid;
b. removing cations by ion exchange using a cation resin using nitric acid as the eluant (regenerant) so that the eluate contains the cations as their nitrate salts;
c. regenerating the cation resin;
d. treating the eluates of the cation ion exchange step;
e. adsorbing anions from the effluent of the cation removal step using an anion exchange resin; and
f. regenerating the anion exchange resin.

2. (canceled)

3. A process as claimed in claim 1 in which the weak to medium base anion exchange resin is the same as used for the adsorption of anions.

4. (canceled)

5. A process as claimed in claim 1 in which a high concentration of nitric acid is used.

6. A process as claimed in claim 1 in which the eluates of the cation ion exchange step are treated by passing ammonia gas therethrough to neutralise any excess acid and converting ferrous ions to ferric ions using air or oxygen to obtain a precipitate as the hydrate at pH 3.5.

7. A process as claimed in claim 6 in which the precipitate is removed by filtration and the filtrate is adjusted to a neutral pH, evaporated and crystallized to form a mixed fertiliser by-product.

8. (canceled)

9. A process as claimed in claim 1 in which the anion exchange resin is a resin with weak base characteristics.

10. A process as claimed in claim 1 in which the effluent from the anion absorption step is water of domestic quality.

11. A process as claimed in claim 1 in which the anion exchange resin is regenerated using ammonia gas introduced into a circulating solution of ammonium sulphate passing through the resin.

12. A process as claimed in claim 11 in which ammonium sulphate is removed from the circulating eluate by bleeding off a stream and concentrating it to a saturated solution or crystallising out a solid fertiliser.

13. A process as claimed in claim 11 in which a scavenger column is used to remove any ammonium anions in the domestic water.

14. A process as claimed in claim 13 in which a cation exchange resin in the hydrogen (acid) form which absorbs the ammonia as the ammonium cation is used in the scavenger column.

15. A process as claimed in claim 14 in which loaded resin from the scavenger column is regenerated with sulphuric acid and the eluate is neutralised and added to the eluate from the anion regeneration step.
